(19) United States
(12) Patent Application Publication
(10) Pub. No.: US 2024/0030545 A1
(43) Pub. Date: Jan. 25, 2024

(54) SEALED BATTERY

(71) Applicants: PRIME PLANT ENERGY & SOLUTIONS, INC., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yozo UCHIDA, Toyota-shi (JP); Tsuyoshi EHARA, Toyota-shi (JP); Yuki SATO, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP)

(21) Appl. No.: 18/331,938

(22) Filed: Jun. 9, 2023

(30) Foreign Application Priority Data
Jul. 25, 2022 (JP) 2022-118103

(51) Int. Cl. H01M 50/325; H01M 50/15; H01M 50/103

(52) U.S. Cl. CPC H01M 50/325; H01M 50/15; H01M 50/103

(57) ABSTRACT

In a sealed battery provided with an electrode body and a battery case accommodating the electrode body, the battery case includes a case body having an opening and accommodating the electrode body, and a plate-shaped lid closing the opening of the case body. The lid includes a safety valve made of resin. The safety valve is formed with a ring-shaped groove that is recessed in a thickness direction of the lid and has a ring shape in plan view. In the safety valve, a thinnest portion having a thinnest thickness in the safety valve includes a ring-shaped thinnest portion of a ring shape in plan view including the bottom of the ring-shaped groove.

### CROSS-REFERENCE TO RELATED APPLICATIONS

This application is based upon and claims the benefit of priority to Japanese Patent Application No. 2022-118103 filed on Jul. 25, 2022, the entire contents of which are incorporated herein by reference.

### BACKGROUND

### Technical Field

The present disclosure relates to a sealed battery.

### Related Art

Japanese unexamined patent application publication No. 2018-041668 discloses a sealed battery provided with an electrode body and a metal battery case accommodating the electrode body. The battery case is provided with a rectangular box-shaped case body having an opening, and a metal lid member closing the opening of the case body. The case body and the lid member are integrated together by welding, constituting the battery case. The lid member is provided, at its center, with a safety valve. This safety valve is made of metal integrally with the lid member.

The safety valve is thinner than other portions of the lid member and formed with a groove on the top surface. Thus, the safety valve actuates when the internal pressure of the battery case reaches a predetermined pressure (i.e., a pressure at which the safety valve opens, hereinafter referred to as a valve opening pressure). Specifically, when the internal pressure of the battery case reaches the valve opening pressure, a portion of the safety valve formed with the groove, that is, a portion overlapping, i.e., including, the bottom of the groove in plan view, ruptures to open the safety valve, thus releasing gas out of the battery case. This configuration can prevent the internal pressure of the battery case from excessively rising, i.e., from reaching a dangerous internal pressure.

### SUMMARY

### Technical Problems

Meanwhile, the groove formed in the safety valve is a groove having a straight line shape in plan view. Accordingly, when the internal pressure of the battery case reaches the valve-opening pressure, a straight portion of the safety valve formed with the groove fractures, or splits off, creating a slit-shaped gas vent hole, through which gas is discharged out of the battery case. However, such a slit-shaped gas vent hole could not quickly discharge the gas out of the battery case. Accordingly, there has been a need for a safety valve that can quickly discharge the gas from inside to outside of a battery case. Furthermore, in order to simplify and properly form a safety valve for a wide variety of sealed batteries, there has been a need to make the safety valve made of resin.

The present disclosure has been made to address the above problems and has a purpose to provide a sealed battery provided with a safety valve that is made of resin and can quickly discharge gas from inside to outside of a battery case when the internal pressure of the battery case rises and reaches a valve-opening pressure.

### Means of Solving the Problems

(1) To achieve the above-mentioned purpose, one aspect of the present disclosure provides a sealed battery comprising: an electrode body; and a battery case accommodating the electrode body, wherein the battery case includes: a case body having an opening and accommodating the electrode body; and a lid having a plate shape and closing the opening of the case body, the lid includes a safety valve made of resin, the safety valve includes a groove recessed in a thickness direction of the lid, and the groove includes a ring-shaped groove having a ring shape in plan view, and the safety valve includes a thinnest portion having a thinnest thickness in the safety valve, and the thinnest portion includes a ring-shaped thinnest portion having a ring shape in plan view including a bottom of the ring-shaped groove.

In the foregoing sealed battery, the thinnest portion of the the safety valve, which has a thinnest thickness in the safety valve, includes the ring-shaped thinnest portion having a ring shape in plan view including the bottom of the ring-shaped groove. Specifically, the ring-shaped portion overlapping, or including, the bottom of the ring-shaped groove of the safety valve in plan view is the ring-shaped thinnest portion that has a smallest thickness in the safety valve. Therefore, when the internal pressure of the battery case reaches the valve-opening pressure, the safety valve breaks open, that is, the ring-shaped thinnest portion fractures, or splits off, thereby creating a cylindrical gas vent hole surrounded by a fractured surface of the ring-shaped thinnest portion. For example, in a safety valve with a ring-shaped groove having a circular ring shape in plan view, the ring-shaped thinnest portion is a circular ring-shaped thinnest portion having a circular ring shape corresponding to the bottom of the ring-shaped groove. Thus, when the safety valve breaks open, the circular ring-shaped thinnest portion fractures, or splits off, creating the cylindrical or nearly cylindrical gas vent hole formed by the fractured surface of the circular ring-shaped thinnest portion.

In the foregoing sealed battery, as described above, when the internal pressure of the battery case reaches the valve-opening pressure, the ring-shaped thinnest portion of the safety valve fractures, creating the cylindrical gas vent hole, which facilitates discharge of gas out of the battery case. When the internal pressure of the battery case is increased by the gas generated in the battery case and reaches the valve-opening pressure, the cylindrical gas vent hole created as above allows the gas to be quickly discharged out of the battery case, and hence the internal pressure of the battery case is rapidly reduced.

The ring-shaped groove may include for example a circular ring-shaped groove having a circular ring shape in plan view, an elliptical groove having an elliptical ring shape in plan view, and other ring shapes. The groove formed in the safety valve may include not only the ring-shaped groove but also any other-shaped grooves, e.g., a straight groove extending linearly. In this case, the thinnest portion with a smallest thickness of the safety valve may include not only the ring-shaped thinnest portion but also any other-shaped portions including the bottom of the other-shaped groove in the safety valve. In other words, the thinnest portion with the smallest thickness of the safety valve may include the ring-shaped thinnest portion and the other-shaped thinnest portion formed by the other-shaped groove.

One example of the lid includes a lid body, which is made of a metal plate and has a cylindrical through hole formed penetrating through the lid body in the thickness direction, and a safety valve that closes the through hole. Another example of the lid is a resin lid, which is made of resin and includes a safety valve as a part of the resin lid.

(2) In the sealed battery described in (1), the ring-shaped groove is a circular ring-shaped groove having a circular ring shape in plan view, and the ring-shaped thinnest portion is a circular ring-shaped thinnest portion having a circular ring shape in plan view.

Since the ring-shaped thinnest portion is the circular ring-shaped thinnest portion, when the safety valve breaks open, the circular ring-shaped thinnest portion fractures, or splits off, creating a cylindrical or nearly cylindrical gas vent hole surrounded by the fractured surface of the circular ring-shaped thinnest portion. This configuration can quickly discharge the gas out of the battery case, thereby rapidly reducing the internal pressure of the battery case.

(3) Furthermore, in the sealed battery described in (1) or (2), the groove of the safety valve includes the ring-shaped groove and further a straight groove having a straight line shape in plan view that bisects a region bounded by the ring-shaped groove in plan view, and the thinnest portion of the safety valve includes the ring-shaped thinnest portion and further a straight thinnest portion having a straight line shape in plan view including a bottom of the straight groove.

In the sealed battery, the thinnest portion of the sealed battery includes the straight thinnest portion in addition to the ring-shaped thinnest portion. This straight thinnest portion has a straight line shape in plan view, which bisects the region bounded by the ring-shaped thinnest portion in plan view. Thus, when the safety valve breaks open, the straight thinnest portion and the ring-shaped thinnest portion fracture, or split off, more quickly creating the gas vent hole than when the only ring-shaped thinnest portion fractures to create the gas vent hole. This configuration can quickly discharge the gas out of the battery case, thereby rapidly reduce the internal pressure of the battery case.

(4) In the sealed battery described in one of (1) to (3), the ring-shaped groove may have a V shape in cross section so that a width of the groove is smaller from the open edge toward the bottom of the groove.

Since the groove of the V-shaped cross-section is very small in width of the bottom, the width of the ring-shaped thinnest portion (i.e., the distance between the inner and outer circumferences of the ring-shaped thinnest portion, or the dimension in the direction perpendicular to the thickness direction) is also extremely small. Thus, the fractured surface is formed with high positional accuracy when the ring-shaped thinnest portion is fractured, resulting in high dimensional accuracy of the cylindrical gas vent hole surrounded by the fractured surface. This reduces variations in the size of gas vent hole among multiple batteries and hence reduces variations in gas discharging speed.

(5) The sealed battery described in one of (1) to (4) may be configured such that, the lid includes: a lid body made of a metal plate and formed with a cylindrical through hole penetrating through the lid body in the thickness direction; and the safety valve that closes the through hole, wherein the lid body includes an annular seal surface surrounding an opening edge of the through hole, the safety valve includes an annular joined portion hermetically joined to the annular seal surface and a flat-plate-shaped portion located inside the through hole in plan view, the ring-shaped groove and the ring-shaped thinnest portion are provided in the flat-plate-shaped portion, and when an internal pressure of the battery case reaches a valve-opening pressure, the ring-shaped thinnest portion fractures to create a cylindrical gas vent hole surrounded by a fractured surface of the ring-shaped thinnest portion.

In the foregoing sealed battery, the safety valve is designed to close the through hole of the lid body made of a metal plate. This safety valve includes the annular joined portion hermetically joined to the annular seal surface surrounding the opening edge of the through hole in the lid body. With such an annular joined portion, the safety valve is hermetically joined to the lid body and the through hole is sealed by the safety valve.

In this safety valve, the ring-shaped groove and the ring-shaped thinnest portion are provided in the flat-plate-shaped portion located inside the through hole in plan view. Therefore, when the internal pressure of the battery case reaches the valve-opening pressure, the ring-shaped thinnest portion fractures, or splits off, the cylindrical gas vent hole surrounded by the fractured surface of the ring-shaped thinnest portion is created at a position inside the through hole in plan view. This can discharge the gas from inside to outside of the battery case through the entire cylindrical gas vent hole surrounded by the fractured surface of the ring-shaped thinnest portion.

(6) In the sealed battery described in (5), the annular seal surface is an annular roughened surface having an uneven shape with pits and protrusions, and the resin safety valve is hermetically joined to the annular roughened surface by a part of resin that forms the safety valve, in which the part of the resin enters into the pits of the annular roughened surface to form the annular joined portion.

In the foregoing sealed battery, the annular joined portion of the safety valve is hermetically joined to the annular roughened surface by the resin entering in the pits of the annular roughened surface to form the annular joined portion, the resin being a part of the resin forming the safety valve.

In other words, the anchor effect exerted by biting of the protrusions of the annular roughened surface of the lid body into the annular joined portion of the safety valve ensures that the annular joined portion of the safety valve and the annular roughened surface are hermetically joined to each other. This configuration can enhance the hermeticity between the annular joined portion of the safety valve and the annular roughened surface of the lid body, and thus improve the hermeticity of the sealed battery.

### BRIEF DESCRIPTION OF THE DRAWINGS

FIG. 1 is a plan, or top, view of a sealed battery in an embodiment;

FIG. 2 is a front view of the sealed battery;

FIG. 3 is a cross-sectional view of the sealed battery along a line B-B in FIG. 1;

FIG. 4 is an enlarged view of a section C in FIG. 3;

FIG. 5 is an enlarged view of a part of a lid, including a safety valve, seen from below;

FIG. 6 is a cross-sectional view of the sealed battery along a line J-J in FIG. 1;

FIG. 7 is a plan, or top, view of the lid;

FIG. 8 is a cross-sectional view of the lid along a line D-D in FIG. 7;

FIG. 9 is a plan, or top, view of a lid body;

FIG. 10 is a cross-sectional view of the lid body along a line E-E in FIG. 9;

FIG. 11 is an enlarged view of a section F in FIG. 10;

FIG. 12 is an explanatory view showing that the safety valve in the embodiment breaks open;

FIG. 13 is an enlarged view of a part of a lid, including a safety valve, seen from below in a comparative example 1;

FIG. 14 is an enlarged view of a part of the lid, including the safety valve in the comparative example 1; and

FIG. 15 is an explanatory view showing that the safety valve in the comparative example 1 breaks open.

### DETAILED DESCRIPTION OF THE EXEMPLARY EMBODIMENTS

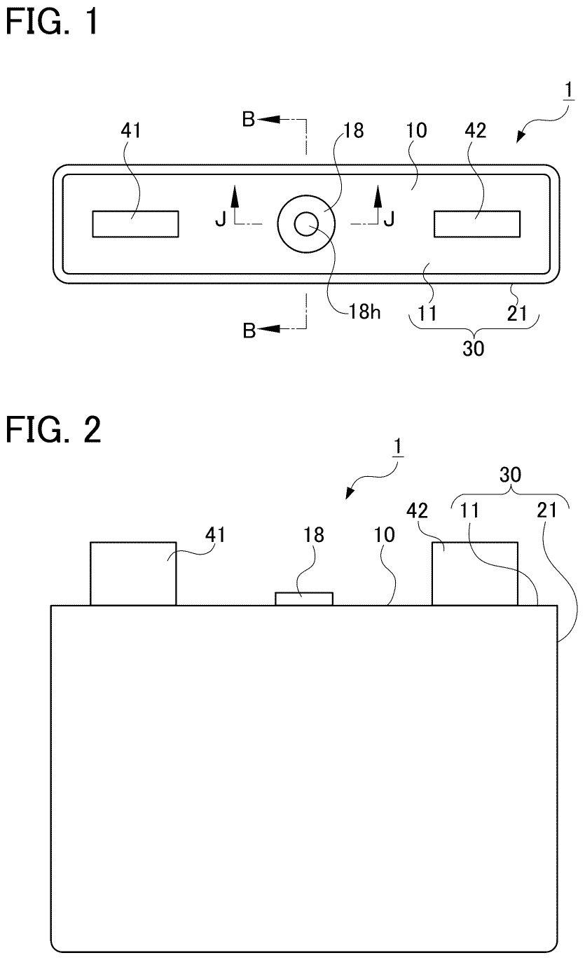

A detailed description of an embodiment of this disclosure will now be given referring to the accompanying drawings. A sealed battery 1 in the present embodiment is a lithium-ion secondary battery and includes a battery case 30, an electrode body 50 accommodated in the battery case 30, a positive terminal 41, and a negative terminal 42 (see FIGS. 1 to 3). The battery case 30 is a hard case having a rectangular parallelepiped box-like shape. This battery case 30 includes a metal case body 21 having a rectangular tubular shape with a closed bottom, and a lid 10 having a rectangular flat plate shape and closing an opening 21b of the case body 21 (see FIGS. 1 to 3). The lid 10 includes a lid body 11 formed of metal in a flat-plate shape and a safety valve 18 made of resin.

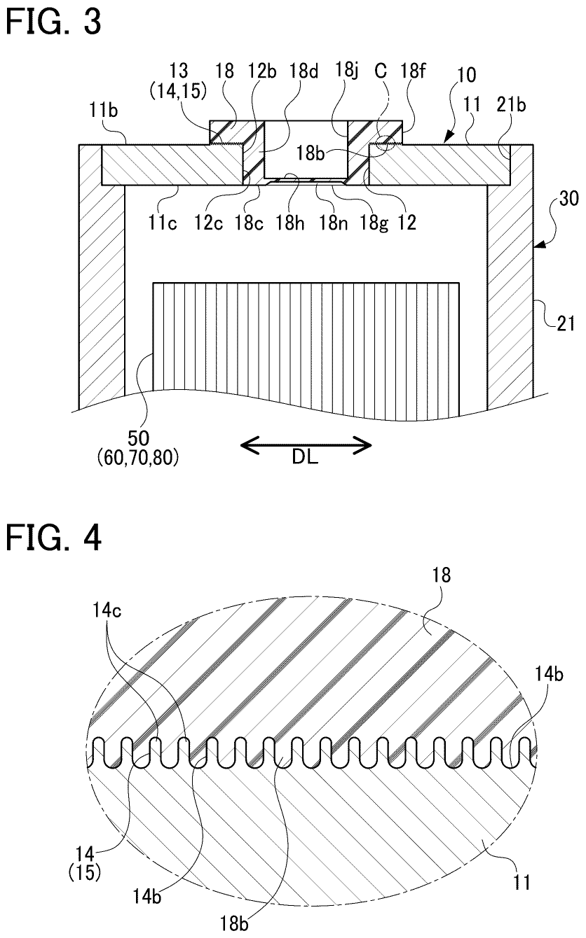

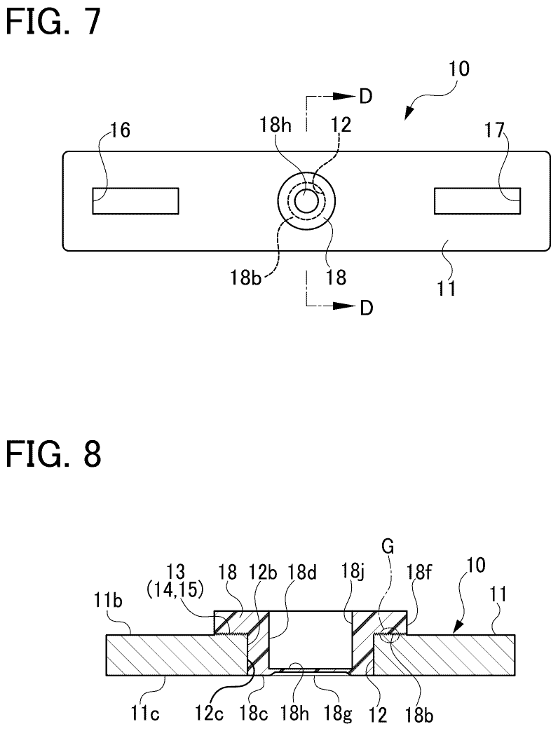

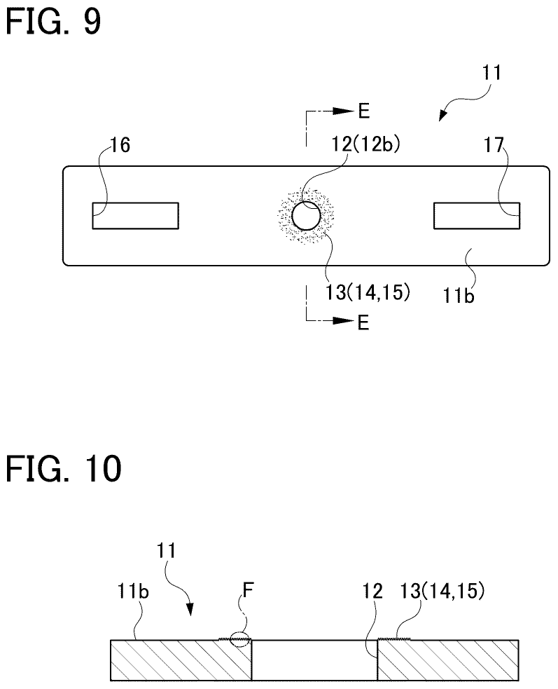

The lid body 11 has a first through hole 16 and a second through hole 17 each having a rectangular shape in plan view and a rectangular cross-section, as shown in FIGS. 7 and 9. The positive terminal 41 is inserted through the first through hole 16, while the negative terminal 42 is inserted through the second through hole 17, as shown in FIGS. 1 and 2. In addition, a tubular insulation member (not shown) is interposed between the inner peripheral surface of the first through hole 16 of the lid body 11 and the outer peripheral surface of the positive terminal 41, and another tubular insulation member (not shown) is interposed between the inner peripheral surface of the second through hole 17 of the lid body 11 and the outer peripheral surface of the negative terminal 42. The lid body 11 is formed with a third through hole 12 having a cylindrical shape penetrating through the lid body 11 in its thickness direction as shown in FIG. 3. This third through hole 12 extends between the outer surface 11b, or the top surface, and the inner surface 11c, or the lower surface to penetrate through the lid body 11.

The electrode body 50 includes positive electrode plates or sheets 60, negative electrode plates or sheets 70, and separators 80 each interposed between the adjacent positive electrode plate 60 and negative electrode plate 70. More concretely, the electrode body 50 is a lamination electrode body provided with a plurality of positive electrode plates 60, a plurality of negative electrode plates 70, and a plurality of separators 80, in which the positive electrode plates 60 and the negative electrode plates 70 are alternately laminated, or stacked, with the separators 80 each interposed therebetween in a lamination direction DL as shown in FIG. 3. The electrode body 50 further contains an electrolytic solution not shown. This electrolytic solution, not shown, is also accommodated within the battery case 30 on the bottom side. The positive electrode plates 60 of the electrode body 50 are connected to the positive terminal 41 through a positive current collecting tab (not shown). The negative electrode plates 70 are connected to the negative terminal 45 through a negative current collecting tab (not shown).

The lid body 11 includes an annular seal surface 15 of a circular ring shape surrounding the opening edge 12b of the third through hole 12 as shown in FIGS. 9 to 11. In the present embodiment, this annular seal surface 15 is provided as a hole-surrounding surface 13, which is a part of the outer surface 11b of the lid body 11 surrounding the opening edge 12b of the third through hole 12.

Furthermore, the lid 10 is provided with a safety valve 18 for closing the third through hole 12 of the lid body 11. This safety valve 18 has a closed-bottom cylindrical shape with a flange, including an annular joined portion 18b hermetically joined to the annular seal surface 15, and an inside portion 18c located inside the third through hole 12 in plan view, as shown in FIGS. 3 and 4. The inside portion 18c includes a cylindrical portion 18j extending in the thickness direction of the lid body 11, i.e., in a vertical direction in FIG. 3, and a flat-plate-shaped portion 18h having a circular disc shape located radially inside relative to the inner peripheral surface of the cylindrical portion 18j. In the present embodiment, the safety valve 18 consists of a first portion 18d having a closed-bottom cylindrical shape and a second portion 18f protruding radially outward from the outer periphery of the first portion 18d. The first portion 18d corresponds to the inside portion 18c. A part of the second portion 18f, located adjacent to the annular seal surface 15, corresponds to the annular joined portion 18b.

The safety valve 18 may be made of a resin with low permeability to an electrolytic solution, for example, polyphenylene sulfide (PPS), polyarylene sulfide (PAS), olefin resin, or fluororesin. In the present embodiment, the safety valve 18 is made of PPS.

As described above, the safety valve 18 includes the annular joined portion 18b hermetically joined to the annular seal surface 15 as shown in FIGS. 3 and 4. The annular joined portion 18b has a circular ring shape in plan view as shown in FIG. 9. With the annular joined portion 18b configured as above, the safety valve 18 is hermetically joined to the lid body 11 and the third through hole 12 is sealed with the safety valve 18.

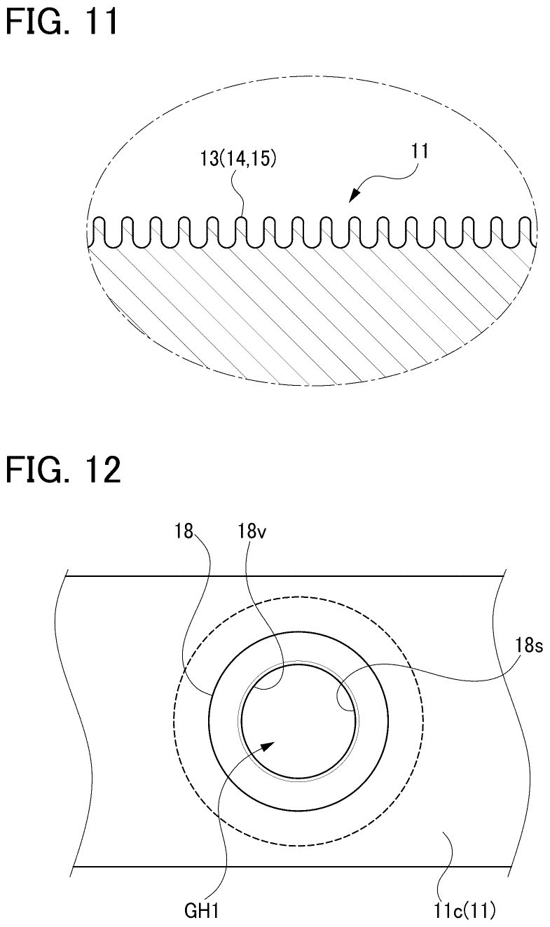

In the present embodiment, particularly, the annular seal surface 15 of the lid body 11 is an annular roughened surface 14 having an uneven shape with pits 14b and protrusions 14c, as shown in FIGS. 4 and 11. This annular roughened surface 14 has a circular ring shape in plan view as shown in FIG. 9. The safety valve 18 is hermetically joined to the annular roughened surface 14 by the annular joined portion 18b made of part of the resin forming the safety valve 18, the part of the resin entering, or penetrating, into the pits 14b of the annular roughened surface 14, as shown in FIG. 4. In other words, the annular joined portion 18b of the safety valve 18 is hermetically joined to the annular roughened surface 14 by the anchor effect exerted by biting of the protrusions 14c of the annular roughened surface 14 into the annular joined portion 18b of the safety valve 18. This can enhance the hermeticity between the annular joined portion 18b of the safety valve 18 and the annular roughened surface 14 of the lid body 11, and hence increase the hermeticity of the sealed battery 1.

The annular roughened surface 14 can be formed by a well-known surface roughening treatment applied to the hole-surrounding surface 13 of the outer surface 11b of the lid body 11. This treatment may include for example a laser surface treatment, a sandblasting treatment, and an anodizing treatment. One example of the laser surface treatment is disclosed in Japanese unexamined patent application publication No. 2022-028587. In the present embodiment, the hole-surrounding surface 13 of the lid body 11 is roughened by the laser surface treatment to form the annular roughened surface 14.

The lid body 11 and the safety valve 18 are integrated by insert molding. Specifically, the lid body 11 and the safety valve 18 constitute the lid 10 (an insert molded product) in which the lid body 11 and the safety valve 18 are integrally molded together as shown in FIGS. 7 and 8. This lid 10 is produced as below. Specifically, the lid body 11 with the annular roughened surface 14 (see FIGS. 9 to 11) is prepared first. With this lid body 11 set as an insert member, the safety valve 18 is made of resin by injection molding. The lid 10 is thus produced as the insert molded product having the lid body 11 and the safety valve 18 integrated together, as shown in FIGS. 7 and 8.

By use of the lid 10 including the lid body 11 and the safety valve 18 integrated together by insert molding, the sealed battery 1 can be easily, appropriately manufactured with the third through hole 12 of the lid body 11 sealed with the safety valve 18. It is noted that a part of the resin injected to mold the safety valve 18, that is, a resin for forming the annular joined portion 18b, enters into the pits 14b of the annular roughened surface 14 of the lid body 11, so that the annular joined portion 18b of the safety valve 18 is hermetically joined to the annular roughened surface 14 of the lid body 11 as shown in FIG. 4.

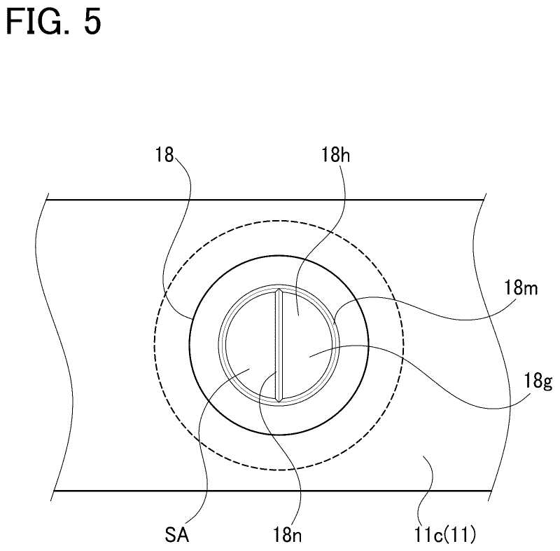

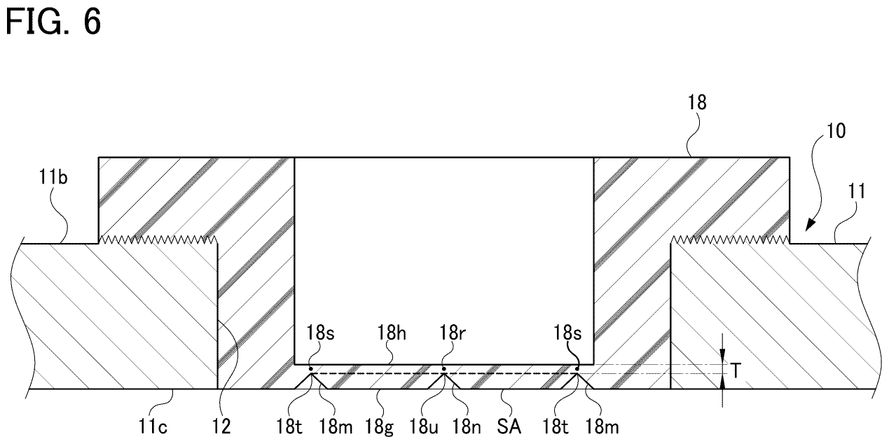

Meanwhile, in the safety valve 18, the flat-plate-shaped portion 18h has a lower surface 18g formed with a circular ring-shaped groove 18m, which is a groove recessed in the thickness direction of the lid body 11 and has a circular ring shape extending circumferentially in plan view, as shown in FIGS. 5 and 6. Furthermore, the safety valve 18 includes a thinnest portion having a thinnest thickness in the safety valve 18, and this thinnest portion include a circular ring-shaped thinnest portion 18s having a circular ring shape in plan view including a bottom 18t of the circular ring-shaped groove 18m. To be specific, the ring-shaped portion of the safety valve 18, overlapping, i.e., including, the bottom 18t of the circular ring-shaped groove 18m in plan view, is the circular ring-shaped thinnest portion 18s having a smallest thickness in the safety valve 18, as shown in FIGS. 5 and 6.

In the sealed battery 1, accordingly, when the internal pressure of the battery case 30 reaches the valve opening pressure, the safety valve 18 breaks open, that is, the circular ring-shaped thinnest portion 18s fractures, or splits off, thereby creating a gas vent hole GH1 of a cylindrical or nearly cylindrical shape, which is surrounded by a fractured surface 18v of the circular ring-shaped thinnest portion 18s, as shown in FIG. 12.

As described above, in the sealed battery 1 of the present embodiment, when the internal pressure of the battery case 30 reaches the valve-opening pressure, the circular ring-shaped thinnest portion 18s of the safety valve 18 fractures, creating the cylindrical gas vent hole GH1, which facilitates discharge of the gas out of the battery case 30. Thus, when the internal pressure of the battery case 30 is increased by the gas generated in the battery case 30 and reaches the valve-opening pressure, the cylindrical gas vent hole GH1 created as above allows gas to be quickly discharged out of the battery case 30, and in turn the internal pressure of the battery case 30 is rapidly reduced.

Furthermore, the groove of the safety valve 18 in the present embodiment includes the circular ring-shaped groove 18m and further a straight groove 18n having a straight line shape passing through the central axis of the the safety valve 18 in plan view that bisects the region SA bounded by the circular ring-shaped groove 18m in plan view, as shown in FIGS. 5 and 6. In the safety valve 18, the thinnest portion having a thinnest thickness includes the circular ring-shaped thinnest portion 18s and a straight thinnest portion 18r formed in a straight line shape in plan view including a bottom 18u of the straight groove 18n. In other words, the thinnest portion of the safety valve 18 includes the straight thinnest portion 18r in addition to the circular ring-shaped thinnest portion 18s. The straight thinnest portion 18r is the thinnest portion extending in a straight line in plan view to divide the region SA bounded by the circular ring-shaped thinnest portion 18s into two equal halves in plan view.

Accordingly, when the safety valve 18 breaks open, the straight thinnest portion 18r and the circular ring-shaped thinnest portion 18s will fracture, or split off. As compared with the configuration that only the circular ring-shaped thinnest portion 18s fractures to create the gas vent hole GH1, the above-described configuration of the present embodiment enables to more quickly create the gas vent hole GH1, so that the gas in the battery case 30 is quickly discharged and hence the internal pressure of the battery case 30 is rapidly reduced.

In the present embodiment, furthermore, the circular ring-shaped groove 18m has a V-shaped cross-section with its width decreasing from the open edge of the circular ring-shaped groove 18m toward the bottom 18t. This circular ring-shaped groove 18m with such a V-shaped cross-section has a very narrow width at the bottom 18t and therefore the circular ring-shaped thinnest portion 18s also has a very small width, which is the distance between the inner and outer circumferences of the circular ring-shaped thinnest portion 18s and corresponds to the dimension in the direction perpendicular to the thickness direction. Accordingly, the fractured surface 18v is generated with high positional accuracy when the circular ring-shaped thinnest portion 18s fractures, so that the cylindrical gas vent hole GH1 surrounded by the fractured surface 18v is created with high dimensional accuracy. This can reduce variations in the size of the gas vent hole GH1 among multiple sealed batteries 1 and thus reduce variations in gas discharging speed.

As described above, in the sealed battery 1 in the present embodiment, the annular joined portion 18b of the safety valve 18 is hermetically joined to the annular seal surface 15 of the lid body 11 to hermetically seal the inside of the battery case 30, whereas the safety valve 18 will open when the internal pressure of the battery case 30 reaches the valve-opening pressure, so that the gas in the battery case 30 is discharged out to prevent the internal pressure of the battery case 30 from excessively rising.

The valve-opening pressure of the safety valve 18 can be adjusted by adjusting the thickness of the the circular ring-shaped thinnest portion 18s and the thickness of the straight thinnest portion 18r of the safety valve 18. This is because the fracture strength of the circular ring-shaped thinnest portion 18s and the fracture strength of the straight thinnest portion 18r respectively depend on the thickness of the circular ring-shaped thinnest portion 18s and the thickness of the straight thinnest portion 18r. The valve-opening pressure of the safety valve 18 corresponds to the internal pressure of the battery case 30 at which those circular ring-shaped thinnest portion 18s and straight thinnest portion 18r fracture, or split off, creating the gas vent hole GH1.

In the sealed battery 1 of the present embodiment, the valve-opening pressure of the safety valve 18 is set based on the thickness T (see FIG. 6) of the circular ring-shaped thinnest portion 18s and the straight thinnest portion 18r. Since the valve-opening pressure is set according to the thickness T of the circular ring-shaped thinnest portion 18s and the straight thinnest portion 18r, this valve-opening pressure can be determined with high accuracy.

TABLE 1

| Thickness (T) of | Valve-opening |
|---|---|
| Thinnest portion (mm) | pressure (MPa) |
| 0.06 | 1.4 |
| 0.10 | 2.0 |
| 0.15 | 2.7 |

Table 1 is a correspondence table showing the relationship between the thickness T (mm) of the circular ring-shaped thinnest portion 18s and the straight thinnest portion 18r and the valve-opening pressure (MPa) of the safety valve 18. As shown in Table 1, for example, in a sealed battery 1 in which the thickness T of the circular ring-shaped thinnest portion 18s and the straight thinnest portion 18r is set to 0.06 mm, the valve-opening pressure can be determined to 1.4 MPa. In another sealed battery 1 in which the thickness T of the circular ring-shaped thinnest portion 18s and the straight thinnest portion 18r is set to 0.10 mm, the valve-opening pressure can be determined to 2.0 MPa. In still another sealed battery 1 in which the thickness T of the circular ring-shaped thinnest portion 18s and the straight thinnest portion 18r is set to 0.15 mm, the valve-opening pressure can be determined to 2.7 MPa. In this manner, the valve-opening pressure of the safety valve 18 can be determined based on the thickness T of the circular ring-shaped thinnest portion 18s and the straight thinnest portion 18r of the safety valve 18.

### Example 1 and Comparative Example 1

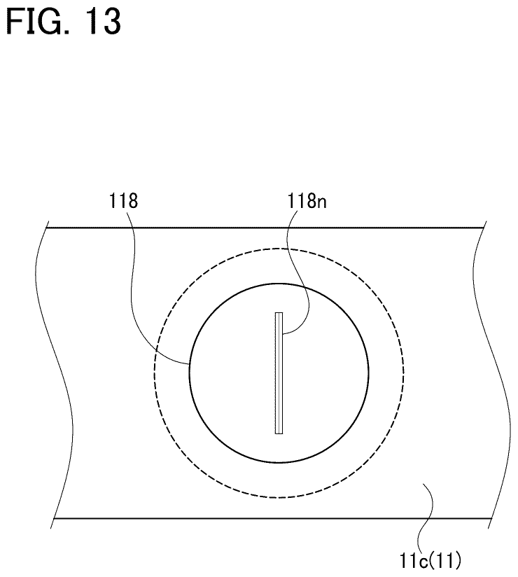

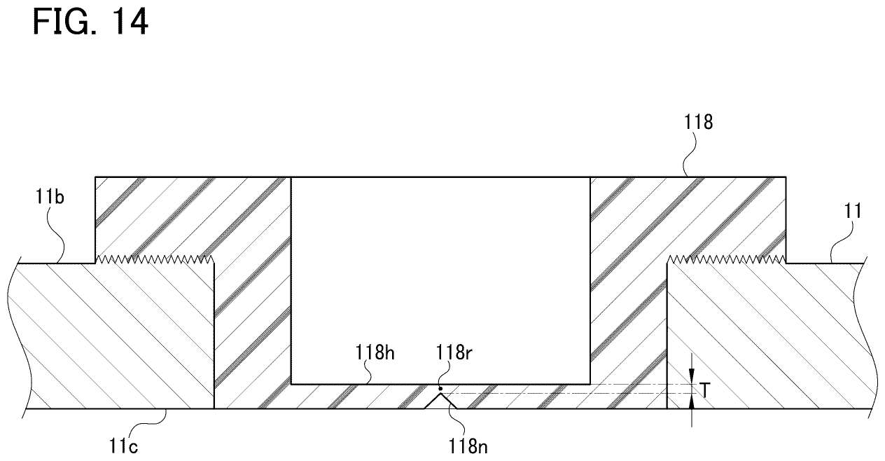

In Example 1, a sealed battery 1 with the circular ring-shaped thinnest portion 18s and the straight thinnest portion 18r each having a thickness T of 0.06 mm was prepared. In Comparative example 1, a sealed battery 1 that differs only in a safety valve from the sealed battery 1 of Example 1 was prepared. Specifically, a safety valve 118 of Comparative example 1, as shown in FIGS. 13 and 14, is identical to the safety valve 18 of Example 1 except that (i) the safety valve 118 includes only a straight groove 118n as the groove, but does not include the circular ring-shaped groove 18m, and (ii) the safety valve 118 includes only a straight thinnest portion 118r as the thinnest portion, but does not include the circular ring-shaped thinnest portion 18s. In the sealed battery of Comparative example 1, as with the sealed battery 1 of Example 1, the thickness T of the straight thinnest portion 118r is set to 0.06 mm. Thus, the sealed battery of Comparative example 1, as with the sealed battery 1 of Example 1, the valve-opening pressure is determined to 1.4 MPa.

### Gas Discharge Test

The sealed batteries of Example 1 and Comparative example 1 were subjected to a gas discharge test. Specifically, each of the sealed batteries was charged to a battery voltage of 5.0 V to come into an overcharged state to generate gas in each battery case. Thus, the internal pressure of each sealed battery rose up to 1.4 MPa, which corresponds to the valve-opening pressure, and each sealed battery broke open. For each sealed battery, the time from when each safety valve breaks open to when the gas is completely removed from the battery case, which is defined as a gas discharge time, was measured. In other words, it was measured the gas discharge time, indicating a time duration from the start of gas discharge from the battery case when the safety valve breaks open until the end of gas discharge from the battery case.

In the sealed battery of Comparative example 1, the gas discharge time was 12.0 seconds. In contrast, the sealed battery of Example 1, the gas discharge time was 4.2 seconds, which is as short as about ⅓ of the gas discharge time in Comparative example 1. This result was achieved for the following reasons.

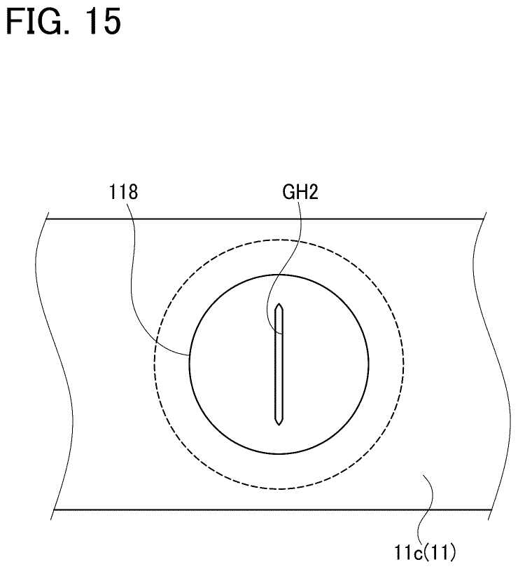

In the sealed battery of Comparative example 1, the safety valve 118 includes the straight groove 118n only as the groove and the straight thinnest portion 118r only as the thinnest portion in a flat-plate-shaped portion 118h, as shown in FIGS. 13 and 14. For this sealed battery of Comparative example 1, therefore, when the internal pressure of the battery case reaches the valve-opening pressure, the straight thinnest portion 118r of the safety valve 118 breaks open, creating a slit-shaped gas vent hole GH2 as shown in FIG. 15, through which gas is discharged out of the battery case. However, it is difficult for such the slit-shaped gas vent hole GH1 to quickly discharge the gas out of the battery case.

In contrast, in the sealed battery 1 of Example 1, the safety valve 18 includes the circular ring-shaped groove 18m as the groove and the circular ring-shaped thinnest portion 18s as the thinnest portion in the flat-plate-shaped portion 18h, as shown in FIGS. 5 and 6. In the sealed battery 1 of Example 1, therefore, when the internal pressure of the battery case 30 reaches the valve-opening pressure, the circular ring-shaped thinnest portion 18s of the safety valve 18 fractures, creating the cylindrical gas vent hole GH1, allowing the gas in the battery case 30 to be more quickly discharged out as compared with the sealed battery of Comparative example 1 in which the slit-shaped gas vent hole GH2 was created. Consequently, in the sealed battery 1 of Example 1, the gas discharge time could be reduced to about ⅓ of that in Comparative example 1.

It is to be understood that the foregoing embodiments are mere examples and give no limitation to the present disclosure, and the present disclosure may be embodied in other specific forms without departing from the essential characteristics thereof.

In the foregoing embodiment, for example, the lid 10 is provided with the safety valve 18 integrally formed together with the lid body 11 by insert molding. Alternatively, a lid may be provided with a resin safety valve made of a resin film welded to a lid body. Still further, the lid may be made of resin including a safety valve as a part of the lid. This resin lid may be produced for example by injection molding of resin.

In the foregoing embodiment, the circular ring-shaped thinnest portion 18s and the straight thinnest portion 18r have the same thickness T but may have different thicknesses from each other. In the foregoing embodiment, the safety valve 18 is provided with the circular ring-shaped groove 18m and the straight groove 18n as the groove and with the circular ring-shaped thinnest portion 18s and the straight thinnest portion 18r as the thinnest portion. As an alternative, the safety valve 18 may be provided with the circular ring-shaped groove 18m only as the groove and the circular ring-shaped thinnest portion 18s only as the thinnest portion. In the safety valve 18 in the foregoing embodiment, the circular ring-shaped groove 18m is provided as the ring-shaped groove and the circular ring-shaped thinnest portion 18s is provided as the ring-shaped thinnest portion. As an alternative, the ring-shaped groove may be provided as any other-shaped ring-shaped groove, e.g., an elliptical groove having an elliptic ring-shape in plan view, and the ring-shaped thinnest portion may be any other-shaped ring-shaped thinnest portions, such an elliptic thinnest portion having an elliptic ring-shape in plan view.

### REFERENCE SIGNS LIST

1 Sealed battery
10 Lid
11 Lid body
12 Third through hole
14 Annular roughened surface (Annular seal surface)
14b Pit
18 Safety valve
18b Annular joined portion
18h Flat-plate-shaped portion
18m Circular ring-shaped groove (Ring-shaped groove)
18n Straight groove
18t, 18u Bottom
18r Straight thinnest portion
18s Circular ring-shaped thinnest portion (Ring-shaped thinnest portion)
21 Case body
21b Opening
30 Battery case
50 Electrode body
GH1 Gas vent hole

What is claimed is:

1. A sealed battery comprising:
an electrode body; and
a battery case accommodating the electrode body,
wherein
the battery case includes:
a case body having an opening and accommodating the electrode body; and
a lid having a plate shape and closing the opening of the case body,
the lid includes a safety valve made of resin,
the safety valve includes a groove recessed in a thickness direction of the lid, and the groove includes a ring-shaped groove having a ring shape in plan view, and
the safety valve includes a thinnest portion having a thinnest thickness in the safety valve, and the thinnest portion includes a ring-shaped thinnest portion having a ring shape in plan view including a bottom of the ring-shaped groove.

2. The sealed battery according to claim 1, wherein
the ring-shaped groove is a circular ring-shaped groove having a circular ring shape in plan view, and
the ring-shaped thinnest portion is a circular ring-shaped thinnest portion having a circular ring shape in plan view.

3. The sealed battery according to claim 1, wherein
the groove of the safety valve includes the ring-shaped groove and further a straight groove having a straight line shape in plan view that bisects a region bounded by the ring-shaped groove in plan view, and
the thinnest portion of the safety valve includes the ring-shaped thinnest portion and further a straight thinnest portion having a straight line shape in plan view including a bottom of the straight groove.

4. The sealed battery according to claim 2, wherein
the groove of the safety valve includes the ring-shaped groove and further a straight groove having a straight line shape in plan view that bisects a region bounded by the ring-shaped groove in plan view, and
the thinnest portion of the safety valve includes the ring-shaped thinnest portion and further a straight thinnest portion having a straight line shape in plan view including a bottom of the straight groove.
